(19) United States
(12) Patent Application Publication
(10) Pub. No.: US 2012/0239589 A1
(43) Pub. Date: Sep. 20, 2012

(54) SYSTEM AND METHOD FOR MAINTAINING A BUSINESS CATALOG

(75) Inventors: Ignacio Rodriguez, Buenos Aires (AR); Leandro Luck, Buenos Aires (AR); Juan Cruz Nores, Buenos Aires (AR); Paulo Gustavo Veiga, Buenos Aires (AR); Emilio Lopez Gabeiras, Buenos Aires (AR)

(73) Assignee: ORACLE INTERNATIONAL CORPORATION, Redwood Shores, CA (US)

(21) Appl. No.: 13/047,645

(22) Filed: Mar. 14, 2011

(51) Int. Cl. G06Q 10/00

(52) U.S. Cl. 705/343

(57) ABSTRACT

A system and method for integrating components with processes in a business catalog. The method comprises constructing a composite model of available components on a computer. The composite model defines functional dependencies between the available components. The method further comprises generating, based on the composite model, a plurality of business objects for the available components and automatically generating a synthesized module for each business object. Each synthesized module includes mechanically generated names for services offered by its associated business object. The method also comprises populating a business catalog with the synthesized modules.

### CROSS REFERENCE TO RELATED APPLICATIONS

This application is related to U.S. Patent Applications “SYSTEM AND METHOD FOR CREATING AND MANAGING BUSINESS OBJECTS” (Atty Docket ORACL-05138U50), which is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The invention is generally related to integrating business processes and service components, and particularly to a system and method for maintaining a business catalog.

### BACKGROUND

Service Component Architecture (SCA) and the SCA Assembly Model provide a useful way to see and model Service Oriented Architecture (SOA) systems. However, SCA and the SCA assembly model are oriented for the information technology (IT) specialist. Such systems can be difficult for business users who are often unfamiliar or uninterested in such technical implementation details. Such business users are more accustomed to working with business processes, for example by using Business Process Modeling Notation (BPMN) and other business process management, which allows those business users to work with business processes without worrying about specific implementation details.

### SUMMARY

A system and method for integrating components with processes in a business catalog are provided. The method comprises constructing a composite model of available components on a computer. The composite model defines functional dependencies between the available components. The method further comprises generating, based on the composite model, a plurality of business objects for the available components and automatically generating a synthesized object for each business object. Each synthesized object includes mechanically generated names for services offered by its associated business object. The method also comprises populating a business catalog with the synthesized objects.

### BRIEF DESCRIPTION OF THE FIGURES

FIG. 1 is an illustration of an exemplary business process management system, in accordance with an embodiment.

FIG. 2 shows an example of a Business Catalog, in accordance with an embodiment.

FIG. 3 shows an interface for customizing synthesized objects, in accordance with an embodiment.

FIG. 4 shows an interface for organizing a business catalog, in accordance with an embodiment.

FIG. 5 shows a flowchart of a method for integrating components in a business catalog, in accordance with an embodiment.

### DETAILED DESCRIPTION

In the following description, the invention will be illustrated by way of example and not by way of limitation in the figures of the accompanying drawings. References to various embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

Furthermore, in certain instances, numerous specific details will be set forth to provide a thorough description of the invention. However, it will be apparent to those skilled in the art that the invention may be practiced without these specific details. In other instances, well-known features have not been described in as much detail so as not to obscure the invention.

In accordance with an embodiment, a system and method for integrating components with processes in a business catalog are provided. The method comprises constructing a composite model of available components on a computer. The composite model defines functional dependencies between the available components. The method further comprises generating, based on the composite model, a plurality of business objects for the available components and automatically generating a synthesized object for each business object. Each synthesized object includes mechanically generated names for services offered by its associated business object. The method also comprises populating a business catalog with the synthesized objects.

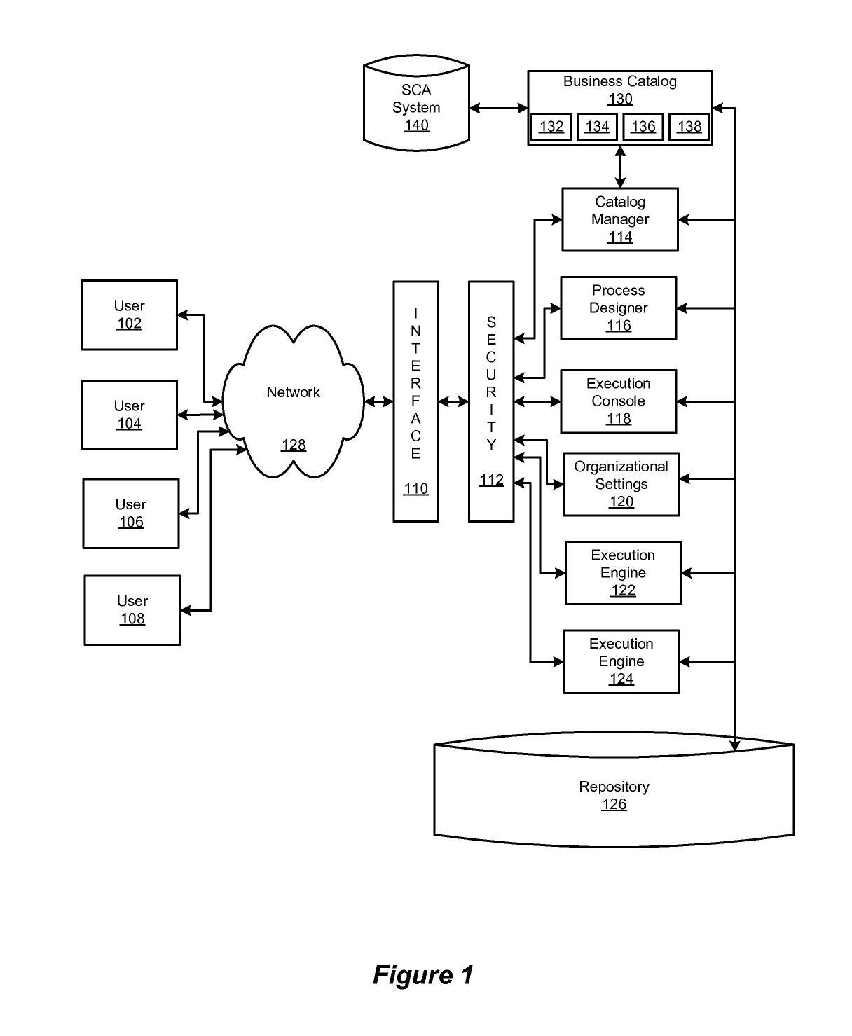

FIG. 1 is an illustration of an exemplary business process management system, in accordance with an embodiment. Although this diagram depicts components as logically separate, such depiction is merely for illustrative purposes. It will be apparent to those skilled in the art that the components portrayed in this figure can be arbitrarily combined or divided into separate software, firmware and/or hardware. Such components, regardless of how they are combined or divided, can execute on the same computing device or can be distributed among different computing devices connected by one or more networks or other suitable communication means. Furthermore, it will also be apparent to one of ordinary skill in the art that certain components can be added, interchanged or removed from this figure without departing from the scope of the various embodiments.

As illustrated, a business process management system can include a set of software modules that can be accessed via a network 128 (e.g. the internet), by various users 102, 104, 106, 108. The network 128 can include wired or wireless communication-based, radio frequency (RF)-based, satellite, microwave or any other form of communication network where exchange of data is enabled between the components connected thereto. In various embodiments, the BPM system includes an interface layer 110, such as a graphical user interface (GUI) accessible via a website or portal, for allowing a user to design, manipulate, execute and monitor the performance of various processes. Furthermore, the system can include a security layer 112 that enables user authentication and authorization of services to the system.

In one embodiment, the BPM system includes a catalog manager 114 that is used to define and specify the components or programs that are called from a business process. These BPM components can include compiled software programs, classes or routines that are stored by the catalog manager in a data repository 126 or in a business catalog 130. In one embodiment, the catalog manager defines, describes and organizes the software components.

The process designer module 116 can be used to draw and design business process models by the users of the BPM system. Once the process is designed by using the process designer, its definition file can be generated and stored on a local or remote computer. The designer can also publish the created business processes. Once the designed business process is published, it can be stored into the data repository 126 and can later be deployed to an execution engine 122, 124 for executing.

The execution console 118 can be used by various users of the system in order to manage any of the execution engines 122, 124 which have process instances executing thereon. In one embodiment, the execution engines are used to deploy the published business processes, execute tasks by the users, and perform automatic business process activities and perform any other tasks needed by each activity of the process instance. The execution engines 122, 124 can manage the execution of each process instance. One example of such process instance is processing a specific sales order using a general business process for processing sales orders. The execution engine can retrieve and collect business process definitions from the repository, manage the execution of a particular user-interactive task or automatically execute the task if it is automated.

A BPM server can maintain the state of each executing process instance in the repository 126. A repository can include a relational database management system (RDBMS), file storage, content management systems as well as any other form of data storage systems. During the execution of the instance, persistent variables can maintain the values for each activity/task of the specific process instance. These variables can be stored in the repository and can be associated with the specific process instance.

In various embodiments, persistent variables can include instance variables and argument variables. Instance variables can record values that may be passed from one activity of a business process to another activity within the same business process. As such, instance variables maintain the state of the instance within the context of the business process. Argument variables, on the other hand record values that may be passed from one business process or instance to another business process or instance.

In accordance with an embodiment, the business catalog 130 can be used to combine service component architecture (SCA) with business processes. Using the business catalog, the functionality of SCA can be provided while hiding implementation details that an ordinary business user is not interested in. The business catalog can be populated with a plurality of business objects 132-138 representing components gathered from an SCA System 140 and user-created components added directly to the business catalog or stored in the repository. The components in the business catalog are made available for process designers to incorporate into their business processes as needed.

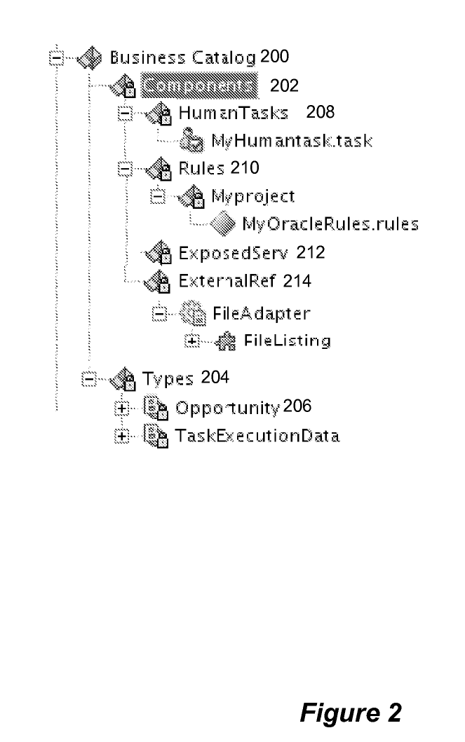

FIG. 2 shows an example of a Business Catalog, in accordance with an embodiment. As shown in FIG. 2, Business Catalog 200 can include a plurality of business objects and components organized in a hierarchical manner in which the Business Catalog is the root having a plurality of modules. In FIG. 2, the Business Catalog includes a Components 202 module and a Types 204 module, each of which include a plurality of submodules. Complex Types arguments, for instance, MyBusinessRule.DecisionFunction_{—}1 (input 1: Opportunity) can be represented as a Synthesized Object. This would be automatically created in the Types module: Opportunity 206. Additionally, External References, Exposed Services and Components can be organized by modules inside of the Components module. As shown in FIG. 2, Components can include HumanTasks 208, Rules 210, Exposed Services 212, and External References 214. Other modules, such as Mediators can also be included in the Components module.

In accordance with an embodiment, a business catalog can be used to combine two different technologies: service component architecture (SCA) which defines relationships between services at a level of detail that is appropriate for an IT user; and business processes, such as those based on business process modeling notation (BPMN), which are defined at a higher level of abstraction more appropriate for a business user. The business catalog can bridge these two worlds by providing all of the functionality of SCA while hiding implementation details that an ordinary business user is not interested in.

A business view of SCA components can provide an unified component model; component customization and decoration; and components which maintain the underlying (run-time) type identity. In accordance with an embodiment, the business view can be dynamically constructed so it is kept in sync with the underlying SCA Assembly Model. Although component customization is optional, when a component is customized all references to the original component, can be automatically updated to reference the newly customized component.

As used herein, a component can be thought of as a set of attributes and a set of operations, plus additional meta-data (such as inheritance information, documentation, etc.). Defined as such, a component is similar to the concept of a class in an object-oriented language. In accordance with an embodiment, most components are dynamically constructed from information gathered from an SCA model, but there are also user-created components and customization information. These user-created components are persisted since they are not part of the SCA model.

As noted above, and in accordance with an embodiment, the Business Catalog can be organized by modules. Those modules can fall into one of at least two categories: synthesized, and not synthesized (which are referred to herein simply as modules). Synthesized modules can be automatically created to include synthesized objects which are based on the available SCA components in the SCA composite model. Those synthesized modules' names are reserved such that users cannot create their own modules having those names. Modules and Synthesized modules can be represented with different icons.

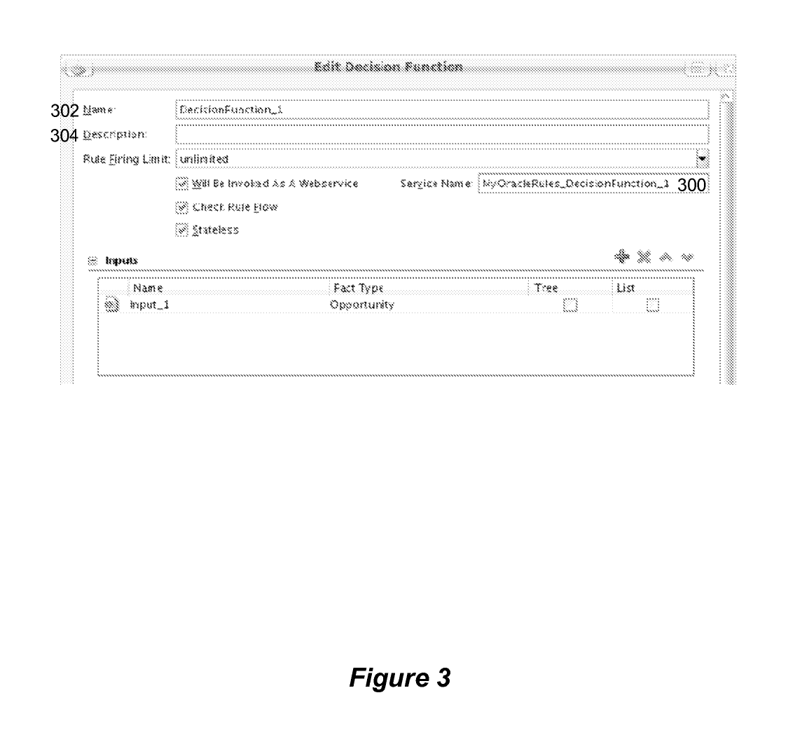

FIG. 3 shows an interface for customizing a synthesized object, in accordance with an embodiment. As shown in FIG. 3, a synthesized object can be automatically created for a service. In this example, a synthesized object is automatically constructed for the service MyOracleRules_DecisionFunction_{—}1 300, and this synthesized object is automatically named Decision_Function_{—}1 302. A user can then add a description 304, modify the automatically generated name, and/or customize other details of the object. The automatically generated synthesized object is a temporary object, when the user customizes the object, which creates a custom component, the custom component is saved and the synthesized object is discarded. As such, synthesized objects are automatically generated by the system for available components, before a user has had a chance to customize the components.

In accordance with an embodiment, the synthesized objects are mechanically generated and provide a more user friendly object for the user to utilize, as compared to the raw component. Each synthesized object is fully operational and the user can choose whether to customize it. Although the synthesized objects are more user friendly than the raw SCA components, customization enables the user to tailor the synthesized objects to meet his or her needs. Once the user customizes the synthesized object, the new customized component is stored and the synthesized object is discarded. For any given component, the user is presented with either the synthesized object or a customized component, but never both at the same time for the same original component.

In accordance with an embodiment, synthesized objects are objects that exist in memory while the project is open and can be created on demand. Modules and/or objects created to model Composite External References, Exposed Services and Components can also be synthesized. Synthesized objects can be customized, with the exception of those objects created by Human Task and Business Rules. Additionally, Synthesized Types can be created to model complex type arguments; Synthesized Types can also be customized. Synthesized objects are generally customizable, which means that a user can create a new Business Object based on the synthesized object. The user can name this new Business Object and move it to a particular module, allowing the user to organize the Business Catalog.

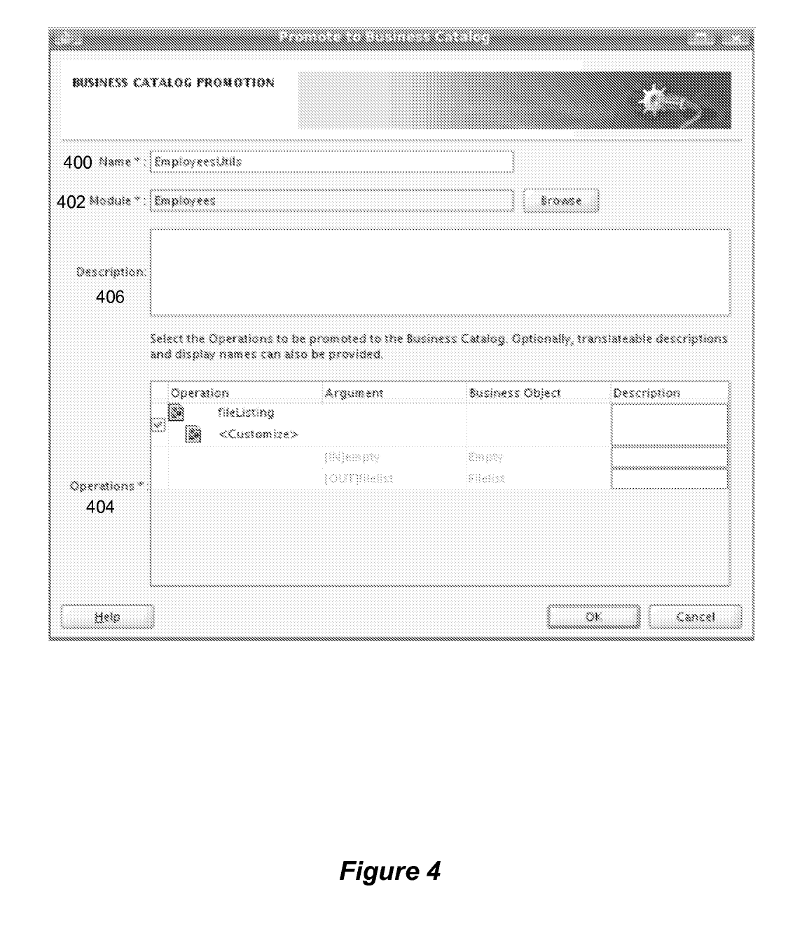

FIG. 4 shows an interface for organizing a business catalog, in accordance with an embodiment. As noted above, the Business Catalog can be organized by modules; provide seamless integration with the SCA composite components and concepts; and automatically model Composite External References, Exposed Services and Components. Additionally, the Business Catalog can provide a business friendly representation of services and components that are available. The business catalog can be a container of the various components which are available to be used by business processes. This can be populated from at least two sources: the SCA Model and user-defined components on the business side. The user can organize the business catalog by selecting a component 400 and a module 402. The user can then select from available operations 404 to be added to the business catalog as well as optionally provide a description 406.

In accordance with an embodiment, IT users can decorate, or customize, components in the business catalog to make them easier to use. Decorating a component can make the component look and/or behave differently. For example, if a component exposes a service with a clumsy name then, by decorating it, the name of that service can be modified to something that is more user friendly. Thus, without modifying the existing service, a new custom service can be created with whatever names the user chooses. In addition to altering names of services, functionality that the end user will not use can be hidden. This streamlines the services and makes them easier to use by eliminating unnecessary or extraneous portions of services. Similarly, decoration allows additional documentation to be added to the services, in another effort to improve the end user's experience.

Each customized service can be synchronized and mapped to the original service throughout the model. In accordance with an embodiment, this synchronization can be performed automatically. For example, if an original service has been used in a number of business processes and the business process designer later decides to create a custom service for that original service, that custom service will automatically be propagated to all of the business processes which use the original service. Similarly, if a custom service is removed, it will automatically be replaced with the original service wherever the custom service was used.

In accordance with an embodiment, the underlying representation for each component is standard compliant (for example, WSDL or XSD), with SCA, but each component is presented to the user as though they are working with a black box—it has a name, it has attributes, it can be used to perform particular operations, it has documentation. This results in a more user-friendly experience for the typical business user, in which most of the implementation details are hidden.

A composite model, in accordance with an embodiment, can be constructed using information about available services and components and their interdependencies. SCA is built around the notion of a composite which can be an XML document which defines the relationships and the contract (i.e., who communicates with whom) between service processes. This provides a description of the functional dependency between different components, including the various services that the SCA components are configured to expose and consume. Using this information, a composite model can be constructed which represents the available services and how those services interact. Based on the composite model, the system can determine what services and components are available and generate a set of business objects.

As described above, the system can generate a composite model which defines the runtime structure of the system. The system can further populate in the business catalog with the processes that are available and with the services and components which those processes are configured to call. The system can then allow for decorations. As described above, if a service has an obtuse or clumsy name for an operation then it can be changed, without modifying the original service. In addition to changing the names of operations, decorations can also be used to hide operations; create fictional operations based on the real ones; add documentation; and generally make the operations more user friendly. Further, the system can keep decorations synchronized with the services.

Additionally, if a raw, original service is used in a plurality of different processes, and the user then decides to add decorations to that service, the original service is updated automatically throughout the model to the customized version. Similarly, if the user removes the customized version, then the system can mechanically generate one which is substituted automatically for the customized version.

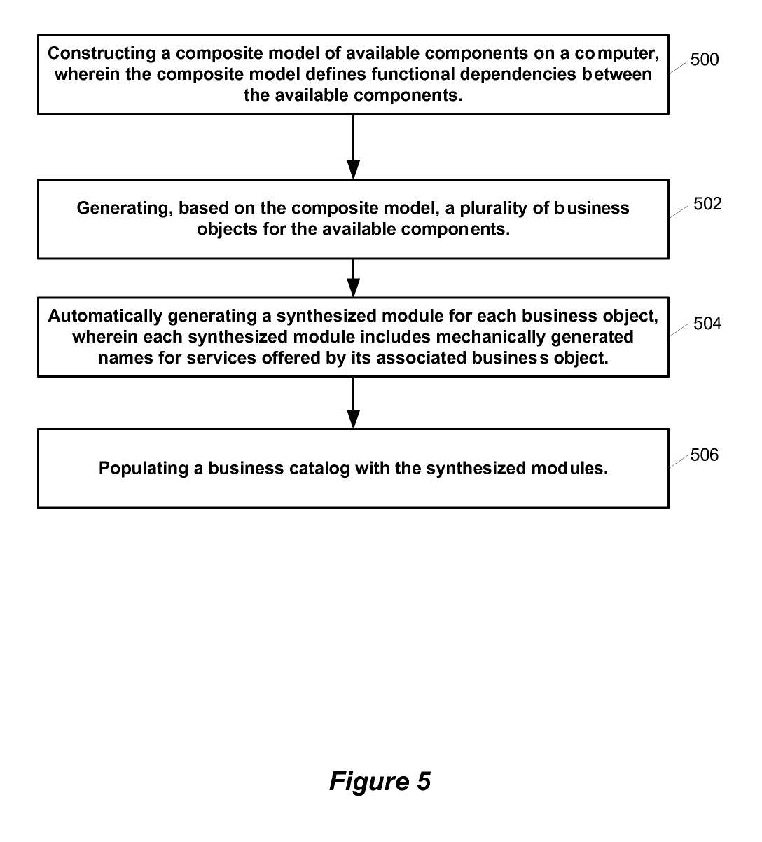

FIG. 5 shows a flowchart of a method for integrating components in a business catalog, in accordance with an embodiment. At step 500, a composite model of available components on a computer is constructed, wherein the composite model defines functional dependencies between the available components. At step 502, a plurality of business objects for the available components are generated, based on the composite model. At step 504, a synthesized object is automatically generated for each business object, wherein each synthesized object includes mechanically generated names for services offered by its associated business object. At step 506, a business catalog is populated with the synthesized objects. Additionally, the composite model can further define services which each component is configured to expose and consume.

In accordance with an embodiment, the method shown in FIG. 5 can also include receiving a request to customize a synthesized object. The request can include one or more of changing a name of a service, hiding a service, and adding documentation for a service. The method can further include creating a custom component based on the request; and discarding the synthesized object.

In accordance with an embodiment, the method shown in FIG. 5 can further include synchronizing the custom component with those processes that include the synthesized object. Synchronizing can include replacing the synthesized object with the custom component. The method can also include deleting the custom component and generating a new synthesized object. Additionally, the method can include synchronizing the new synthesized object with those processes that include the custom component, wherein synchronizing can include replacing the custom component with the new synthesized object.

In accordance with an embodiment, the method shown in FIG. 5 can further include receiving a request to construct a first business process and receiving a request to access the business catalog to identify one or more synthesized objects. The method can further include receiving a request to incorporate the one or more synthesized objects from the business catalog into the first business process, and deploying the first business process. Additionally, method can include receiving a request to customize the one or more synthesized objects. One or more custom components can be created based on the request and the one or more synthesized objects in the first business process can be automatically replaced with the corresponding one or more custom components.

The present invention can be conveniently implemented using one or more conventional general purpose or specialized digital computer, computing device, machine, or microprocessor, including one or more processors, memory and/or non-transitory computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a computer readable storage medium (media) having instructions stored thereon/in which can be used to program a computer to perform any of the processes of the present invention. The computer readable storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method for integrating components with processes in a business catalog, comprising:
constructing a composite model of available components on one or more computers, including a computer readable medium and processor, wherein the composite model defines functional dependencies between the available components;
generating, based on the composite model, a plurality of business objects for the available components;
automatically generating a synthesized object for each business object, wherein each synthesized object includes mechanically generated names for services offered by its associated business object; and
populating a business catalog with the synthesized objects.

2. The method of claim 1 wherein the composite model further defines services which each component is configured to expose and consume.

3. The method of claim 1, further comprising:
receiving a request to customize a synthesized object, wherein the request can include one or more of changing a name of a service, hiding a service, and adding documentation for a service;
creating a custom component based on the request; and
discarding the synthesized object.

4. The method of claim 3 further comprising:
synchronizing the custom component with those processes that include the synthesized object, wherein synchronizing can include replacing the synthesized object with the custom component.

5. The method of claim 3 further comprising:
deleting the custom component;
generating a new synthesized object; and
synchronizing the new synthesized object with those processes that include the custom component, wherein synchronizing can include replacing the custom component with the new synthesized object.

6. The method of claim 1 further comprising:
receiving a request to construct a first business process;
receiving a request to access the business catalog to identify one or more synthesized objects;
receiving a request to incorporate the one or more synthesized objects from the business catalog into the first business process; and
deploying the first business process.

7. The method of claim 6 further comprising:
receiving a request to customize the one or more synthesized objects;
creating one or more custom components based on the request;
automatically replacing the one or more synthesized objects in the first business process with the corresponding one or more custom components.

8. A system for integrating components with processes in a business catalog, comprising:
one or more computers, each including a computer readable medium and processor;
a composite model of available components stored on the one or more computers, wherein the composite model defines functional dependencies between the available components;
a plurality of business objects for the available components, wherein the business objects are generated based on the composite model;
a plurality of synthesized objects, wherein a synthesized object is automatically generated for each business object, and wherein each synthesized object includes mechanically generated names for services offered by its associated business object; and
a business catalog that is populated with the synthesized objects.

9. The system of claim 8 wherein the composite model further defines services which each component is configured to expose and consume.

10. The system of claim 8, wherein the computer is configured to:
receive a request to customize a synthesized object, wherein the request can include one or more of changing a name of a service, hiding a service, and adding documentation for a service;
create a custom component based on the request; and discard the synthesized object.

11. The system of claim 10 wherein the computer is further configured to:
synchronize the custom component with those processes that include the synthesized object, wherein synchronizing can include replacing the synthesized object with the custom component.

12. The system of claim 10 wherein the computer is further configured to:
delete the custom component;
generate a new synthesized object; and
synchronize the new synthesized object with those processes that include the custom component, wherein synchronizing can include replacing the custom component with the new synthesized object.

13. The system of claim 8 wherein the computer is further configured to:
receive a request to construct a first business process;
receive a request to access the business catalog to identify one or more synthesized objects;
receive a request to incorporate the one or more synthesized objects from the business catalog into the first business process; and
deploy the first business process.

14. The system of claim 13 wherein the computer is further configured to:
receive a request to customize the one or more synthesized objects;
create one or more custom components based on the request;
automatically replace the one or more synthesized objects in the first business process with the corresponding one or more custom components.

15. A non-transitory computer readable storage medium including instructions stored thereon which, when executed by a computer, cause the computer to perform the steps of:
constructing a composite model of available components on one or more computers, each computer including a computer readable medium and processor, wherein the composite model defines functional dependencies between the available components;
generating, based on the composite model, a plurality of business objects for the available components;
automatically generating a synthesized object for each business object, wherein each synthesized object includes mechanically generated names for services offered by its associated business object; and
populating a business catalog with the synthesized objects.

16. The non-transitory computer readable storage medium of claim 15 wherein the composite model further defines services which each component is configured to expose and consume.

17. The non-transitory computer readable storage medium of claim 15, further comprising:
receiving a request to customize a synthesized object, wherein the request can include one or more of changing a name of a service, hiding a service, and adding documentation for a service;
creating a custom component based on the request; and
discarding the synthesized object.

18. The non-transitory computer readable storage medium of claim 17 further comprising:
synchronizing the custom component with those processes that include the synthesized object, wherein synchronizing can include replacing the synthesized object with the custom component.

19. The non-transitory computer readable storage medium of claim 17 further comprising:
deleting the custom component;
generating a new synthesized object; and
synchronizing the new synthesized object with those processes that include the custom component, wherein synchronizing can include replacing the custom component with the new synthesized object.

20. The non-transitory computer readable storage medium of claim 15, further comprising:
receiving a request to construct a first business process;
receiving a request to access the business catalog to identify one or more synthesized objects;
receiving a request to incorporate the one or more synthesized objects from the business catalog into the first business process; and
deploying the first business process.
